(19) United States
(12) Patent Application Publication
(10) Pub. No.: US 2006/0187785 A1
(43) Pub. Date: Aug. 24, 2006

(54) Method and apparatus for demodulating WAP of optical disc

(75) Inventor: Masashi Yamawaki, Kasugai (JP)

Correspondence Address: ARENT FOX PLLC, 1050 CONNECTICUT AVENUE, N.W., SUITE 400, WASHINGTON, DC, 20036, US

(73) Assignee: Fujitsu Limited

(21) Appl. No.: 11/223,954

(22) Filed: Sep. 13, 2005

(30) Foreign Application Priority Data
Feb. 23, 2005 (JP) 2005-047535

(51) Int. Cl. G11B 5/09

(52) U.S. Cl. 369/47.35; 369/59.19; 369/59.1

(57) ABSTRACT

A method for demodulating a WAP of an optical disc that ensures the read rate of address information while improving the reading accuracy. The method includes detecting in full bits a head invert phase wobble of each wobble data unit in an address field, and correcting generation timing of a demodulation signal based on the detection result so that the head invert phase wobble is properly detected.

### CROSS-REFERENCE TO RELATED APPLICATIONS

This application is based upon and claims the benefit of priority from the prior Japanese Patent Application No. 2005-047535, filed on Feb. 23, 2005, the entire contents of which are incorporated herein by reference.

### BACKGROUND OF THE INVENTION

The present invention relates to an optical disc record/reproduction apparatus, and more particularly, to a method for demodulating a wobble address in a periodic position (WAP) that is used to read address information recorded as a wobbling pattern on an HD-DVD disc.

The demand for larger-capacity optical discs has-been increasing in recent years. To meet this demand, HD-DVD discs have been developed as next-generation optical discs. An HD-DVD-rewritable disc has a disc surface on which grooves and lands are formed. The disc has wobble signals, recorded on the side walls of the grooves in a wobbling manner. Each wobble signal is modulated and recorded as preformat data, such as address information. This recording technique enables efficient use of the data recording area of the disc, and increases the recording capacity of the disc.

FIG. 1 is a schematic block diagram showing an optical disc record/reproduction apparatus 100. The optical disc record/reproduction apparatus 100 reproduces the WAP before performing a data write operation. The operation of the apparatus 100 for reproducing a WAP will now be described.

In a WAP reproduction mode, a read channel unit 3 reads a wobble signal from a disc 1 with a pickup 2 and generates a binary wobble signal, which is provided to a controller 4 with a clock signal CLK. The controller 4 is controlled by a CPU 5. The read channel unit 3 is controlled by the controller 4.

The controller 4 includes a WAP reproduction unit 6. The WAP reproduction unit 6 reproduces a WAP using a wobble signal normal phase wobble (NPW) and a wobble signal invert phase wobble (IPW), which are provided from the read channel unit 3 in accordance with the clock signal CLK, to specify a recording position using the WAP.

Record tracks are spirally formed on the disc 1. The record tracks are divided into a plurality of physical segments having predetermined lengths. Each physical segment has a WAP, which is written as preformat data. One record track includes ten to several tens of physical segments.

To ensure the recording capacity of the disc, the preformat data is recorded as wobble signals in accordance with the wobbling of the grooves. The wobble signal IPW has a phase opposite to the phase of the wobble signal NPW.

FIG. 5 shows the layout of a WAP, which is used to specify the recording position of each physical segment. The WAP is configured by 17 wobble data units (WDUs) that are divided into a SYNC field 8, an address field 9, and a unity field 10.

One WDU is assigned to the SYNC field 8. Thirteen WDUs are assigned to the address field 9. Three WDUs are assigned to the unity field 10.

FIG. 6 shows information recorded in the address field 9. The address field 9 includes three bits of segment information, six bits of a segment address, five bits of a zone address, one bit of an address parity, twelve bits of a group track address, and twelve bits of a land track address.

Japanese Laid-Open Patent Publication No. 2004-303395 describes information stored in the address field 9.

FIG. 7(a) shows the layout of WDU 0, which configures the SYNC field 8. One WDU includes 84 wobbles. The SYNC field 8 includes six wobbles of IPW, four wobbles of NPW, six wobbles of IPW, and sixty-eight wobbles of NPW. IPW represents “1 b”, and NPW represents “0 b”. Bits are modulated incompliance with a rule. At the outer and inner circumferential sides of the disc, NPW is defined if reading is started at the point indicated in FIG. 8(a) and the wobble signals shift, and IPW is defined if reading is started at the point indicated in FIG. 8(b) and wobble signals shift.

FIG. 7(b) shows the layout of one of WDUs 1 to 13 that configure the address field 9. Four wobbles of IPW, four wobbles of bit 2, four wobbles of bit 1, four wobbles of bit 0, and sixty-eight wobbles of NPW are included at the head of the address field 9. In other words, one WDU stores address information of three bits, which are bits 2, 1, and 0. As shown in FIG. 7(c), one WDU of the unity field 10 is configured by 84 wobbles of NPW.

WDU 1 stores three bits of address information as segment information, and WDUs 2 and 3 store six bits of address information as segment addresses. Accordingly, in WDUs 1 to 13, 39 bits of address information are stored from the segment information shown in FIG. 6 as land track address.

FIG. 2 is a schematic block diagram showing the WAP reproduction unit 6 of the prior art. FIG. 3 is a time chart showing a basic operation of the WAP reproduction unit 6. The WDUs of the WAP are sequentially provided to a shift register 11. Each WDU is obtained by reading the wobble signals NPW and IPW from the disc 1 with the pickup 2 and generating binary wobble signals NPW and IPW. The wobble signals (WDUs) are provided to a SYNC detector 12 and to a data converter 13 in units of a predetermined number of bits.

The SYNC detector 12 detects the SYNC field 8, to which the first WDU of the WAP is assigned. In detail, the SYNC detector 12 detects a SYNC pattern of “1111 1100 0011 1111” by dividing the six wobbles of IPW, four wobbles of NPW, and six wobbles of IPW included in WDU 0 of the SYNC field 8 into sections of four bits. Upon detection of the pattern, the SYNC detector 12 provides a WDU/WAP counter 14 and a non-detection counter 17 with a detection signal X1.

The WDU/WAP counter 14 counts 17 WDUs of one WAP in response to the detection signal X1 and counts 84 wobble signals of each WDU. Based on the count values resulting from the count operations, the WDU/WAP counter 14 provides the data converter 13 and a data latch circuit 15 with a demodulation signal Y1 at a predetermined timing.

As shown in FIG. 3, the WDU/WAP counter 14 generates the demodulation signal Y1 when counting the sixteenth wobble signal of each of WDUs 1 to 13 included in the address field 9 (i.e., when wobble signals, each having four wobbles, corresponding to bits 2, 1, and 0 are provided to the data converter 13 after four wobbles of IPW). The demodulation signal Y1 is generated in a locked state at the same timing as the 84 wobble signals of each WDU.

In response to the demodulation signal Y1, the data converter 13 recognizes the wobble signal provided from the shift register 11 as the first IPW of each of WDUs 1 to 13, and recognizes the wobble signal following the first IPW as address information stored in bits 2 to 0. The data converter 13 then demodulates the wobble signals. In the demodulation process, the data converter 13 performs majority determination on each of the wobble signals read from bits 2 to 0 to generate three bits of address information.

In accordance with the demodulation signal Y1, the data latch circuit 15 sequentially latches address information of each of the WDUs 1 to 13 provided from the data converter 13. When completing the reading of one WAP, the data latch circuit 15 provides a parity check circuit 16 with the segment information, the segment address, the zone address, and the track address.

The parity check circuit 16 performs a parity check on the address information stored in the data latch circuit 15. When detecting an error in the address information, the parity check circuit 16 generates an error signal.

The data converter 13 provides the non-detection counter 17 with a non-detection signal Z1 when the IPW of the first four wobbles of each of the WDUs 1 to 13 included in the address field 9 is not detectable.

The non-detection counter 17 counts the non-detection signal Z1. When the count value reaches a predetermined value, the non-detection counter 17 recognizes that the read operation of each of the WDUs 1 to 13 is anomalous, and generates an error signal. An address at which data is written is determined using the segment information, the segment address, the zone address, and the track address, which are read in the WAP read operation.

When the SYNC detector 12 detects the SYNC pattern of the WDU 0, the SYNC detector 12 usually reads the wobble signal “0000” prior to the SYNC pattern. It is preferable that the SYNC detector 12 detect in full bits the pattern “1111 1100 0011 1111 0000” following the wobble signal “0000”. However, this decreases the read rate. As a result, it is highly likely that the address information stored in the address field 9 cannot be properly demodulated.

Therefore, as shown in FIG. 4(a), the SYNC detector 12 is set to generate the detection signal X1 even when two or less of the four bits located at x in the pattern “0000 x111 1x00 00x1 111x 0000” are not detected.

The data converter 13 detects the first IPW “1111” of each of the WDUs 1 to 13. Before doing so, it is preferable that the data converter 13 reads the wobble signal “0000” and then detects in full bits the signals “0000 1111”. However, this would lower the read rate, and the count value of the non-detection counter 17 would increase quickly. Thus, it may become impossible to read the WDUs 1 to 13.

Therefore, as shown in FIG. 4(b), the SYNC detector 12 is set not to generate the non-detection signal Z1 even if “1” cannot be detected at one of the two bits located to the positions of x in pattern “0000 x11x”.

Japanese Laid-Open Patent Publication No. 2004-303395 describes an information recording method that sets the start position of a data segment, which is set based on address information, at the position of an NPW in the SYNC field.

Japanese Laid-Open Patent Publication No. 2004-213870 describes an address reproduction circuit that improves the reliability of the read address information, which is obtained by performing A/D conversion on a wobble signal and performing a maximum likelihood decoding process.

### SUMMARY OF THE INVENTION

The SYNC detector 12 and the data converter 13 perform the read operation on the SYNC field 8 and the address field 9 with lowered detection accuracy to ensure the read rate. To ensure the read rate, the data converter 13 performs the read operation of the WDUs 1 to 13 included in the address field 9. More specifically, the data converter 13 lowers the detection accuracy of the IPW for the first four wobbles. Further, when reading each of the wobble signals of bits 2 to 0, the data converter 13 performs majority determination for every four bits of the wobble signal, and demodulates an address signal of one bit. In this case, when reading the WDUs 1 to 13 in the address field 9, reading is enabled even when data is read at a timing deviated from the clock signal CLK. As a result, correct address information cannot be obtained.

As one such example, referring to FIG. 9, when demodulating IPW and bits 2 to 0, even if demodulation is performed in a state in which a deviation corresponding to one wobble occurs, the data converter 13 determines that the IPW has been properly read, performs majority determination on bits 2 to 0, and demodulates the address information. However, this demodulation operation does not detect an error contained in the demodulated address information. As a result, the address used to write data is not properly demodulated.

The present invention provides a method for demodulating a WAP of an optical disc that ensures the read rate of address information and improves the reading accuracy.

One aspect of the present invention is a method for demodulating an address from a wobble signal recorded on a disc. The disc records a SYNC field and an address field that are configured by a plurality of wobble data units including a first wobble data unit of the SYNC field and a second wobble data unit of the address field. The firs wobble data unit includes a synchronization signal. The second wobble data unit includes a head invert phase wobble, having a plurality of bits, and an address. The method includes generating a plurality of wobble data units using the wobble signal recorded on the disc, detecting the synchronization signal from the first wobble data unit of the SYNC field, counting the plurality of wobble data units based on the detection of the synchronization signal, generating a demodulation signal for setting a timing at which the address in the second wobble data unit of the address field is demodulated based on a count value of the plurality of wobble data units, detecting the head invert phase wobble from the second wobble data unit of the address field in response to the demodulation signal and checking whether the plurality of wobble data units are properly readable, and demodulating the address in the second wobble data unit of the address field in response to the demodulation signal. Detection accuracy of the synchronization signal and the head invert phase wobble is set relatively low to improve read rate of the address. The method further includes detecting in full bit the head invert phase wobble in the second wobble data unit of the address field in parallel with the detection of the head invert phase wobble, and correcting generation timing of the demodulation signal based on the full bit detection result so that the head invert phase wobble is properly detected.

Another aspect of the present invention is a method for demodulating an address from a wobble signal recorded on a disc. The disc records a SYNC field and an address field that are configured by a plurality of wobble data units including a first wobble data unit of the SYNC field and a second wobble data unit of the address field. The firs wobble data unit includes a synchronization signal. The second wobble data unit includes a head invert phase wobble, having a plurality of bits, and an address. The method includes generating a plurality of wobble data units using wobble signal recorded on the disc, detecting the synchronization signal from the firs wobble data unit of the SYNC field, counting the plurality of wobble data units based on the detection of the synchronization signal, continuously generating a plurality of demodulation signals for setting a timing at which the address in the second wobble data unit of the address field is demodulated based on a count value of the plurality of wobble data units, detecting the head invert phase wobble from the second wobble data unit of the address field and checking whether the plurality of wobble data units are properly readable, demodulating a plurality of addresses in the second wobble data unit of the address field in response to each of the plurality of demodulation signals, wherein detection accuracy of the synchronization signal and the head invert phase wobble is set relatively low to improve read rate of the plurality of addresses, detecting whether the plurality of addresses that are demodulated in response to the demodulation signals are proper, and correcting, when detecting that the plurality of addresses are proper, generation timing of one of the plurality of demodulation signals so as to be synchronized with generation timings of the demodulation signal that demodulates the proper plurality of addresses.

A further aspect of the present invention is an apparatus for demodulating an address from a wobble signal recorded on a disc. The disc records a SYNC field and an address field that are configured by a plurality of wobble data units including a first wobble data unit of the SYNC field and a second wobble data unit of the address field. The first wobble data unit includes a synchronization signal. The second wobble data unit includes a head invert phase wobble, having a plurality of bits, and an address. The apparatus includes a SYNC detector for detecting the synchronization signal from the first wobble data unit of the SYNC field and generating a first detection signal. A counter counts the plurality of wobble data units in response to the first detection signal from the SYNC detector and generates a demodulation signal for setting a timing at which the address in the second wobble data unit of the address field is demodulated based on a count value of the plurality of wobble data units. An address demodulator detects the head invert phase wobble in the second wobble data unit of the address field in response to the demodulation signal and demodulates the address in the second wobble data unit of the address field. An IPW monitor detects in full bit the head invert phase wobble of the second wobble data unit of the address field in parallel with the detection of the head invert phase wobble and generates a second detection signal when properly detecting the head invert phase wobble. The counter corrects the count value in response to the second detection signal so that the demodulation signal is generated at a timing in which the head invert phase wobble is properly detectable in full bits.

Another aspect of the present invention is an apparatus for demodulating an address from a wobble signal recorded on a disc. The disc records a SYNC field and an address field that are configured by a plurality of wobble data units including a first wobble data unit of the SYNC field and a second wobble data unit of the address field. The first wobble data unit includes a synchronization signal. The second wobble data unit includes a head invert phase wobble, having a plurality of bits, and an address. The apparatus includes a SYNC detector for detecting the synchronization signal from the first wobble data unit of the SYNC field and generating a first detection signal. A counter counts the plurality of wobble data units in response to the detection signal from the SYNC detector and continuously generates a plurality of demodulation signals for setting a timing at which the address in the second wobble data unit of the address field is demodulated based on a count value of the plurality of wobble data units. An address demodulator detects the head invert phase wobble from the second wobble data unit of the address field in response to each of the plurality of demodulation signals and demodulates a plurality of addresses in the second wobble data unit of the address field. An address comparator detects whether the plurality of addresses are proper, and when detecting that the plurality of addresses are proper, provides the counter with a correction signal for correcting generation timing of one of the plurality of demodulation signals so as to be synchronized with generation timings of the demodulation signal that demodulates the proper plurality of normal addresses.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram showing an optical disc record/reproduction apparatus of the prior art;

FIG. 2 is a schematic block diagram showing a WAP reproduction unit included in the optical disc record/reproduction apparatus of FIG. 1;

FIG. 3 is a time chart showing the operation of the WAP reproduction unit of FIG. 2;

FIGS. 4(a) and 4(b) are diagrams showing an operation for lowering the detection accuracy of wobble signals;

FIG. 5 is a diagram showing the configuration of a WAP;

FIG. 6 is a diagram showing the configuration of an address field in the WAP of FIG. 5;

FIG. 7(a) is a diagram showing the configuration of a SYNC field in the WAP of FIG. 5;

FIG. 7(b) is a diagram showing the configuration of one WDU in the address field of the WAP of FIG. 5;

FIG. 7(c) is a diagram showing the configuration of one WDU in a unity field of the WAP of FIG. 5;

FIGS. 8(a) and 8(b) are diagrams showing the demodulating rule for wobble signals;

FIG. 9 is a diagram showing an erroneous demodulation operation;

FIG. 10 is a schematic block diagram showing a WAP reproduction unit of an optical disc record/reproduction apparatus according to a first embodiment of the present invention;

FIG. 11 is a time chart showing the operation of the WAP reproduction unit of FIG. 10;

FIG. 12 is a schematic block diagram showing a WAP reproduction unit of an optical disc record/reproduction apparatus according to a second embodiment of the present invention; and

FIG. 13 is a time chart showing the operation of the WAP reproduction unit of FIG. 12.

### DETAILED DESCRIPTION OF THE PREFERRED EMBODIMENTS

In the drawings, like numerals are used for like elements throughout.

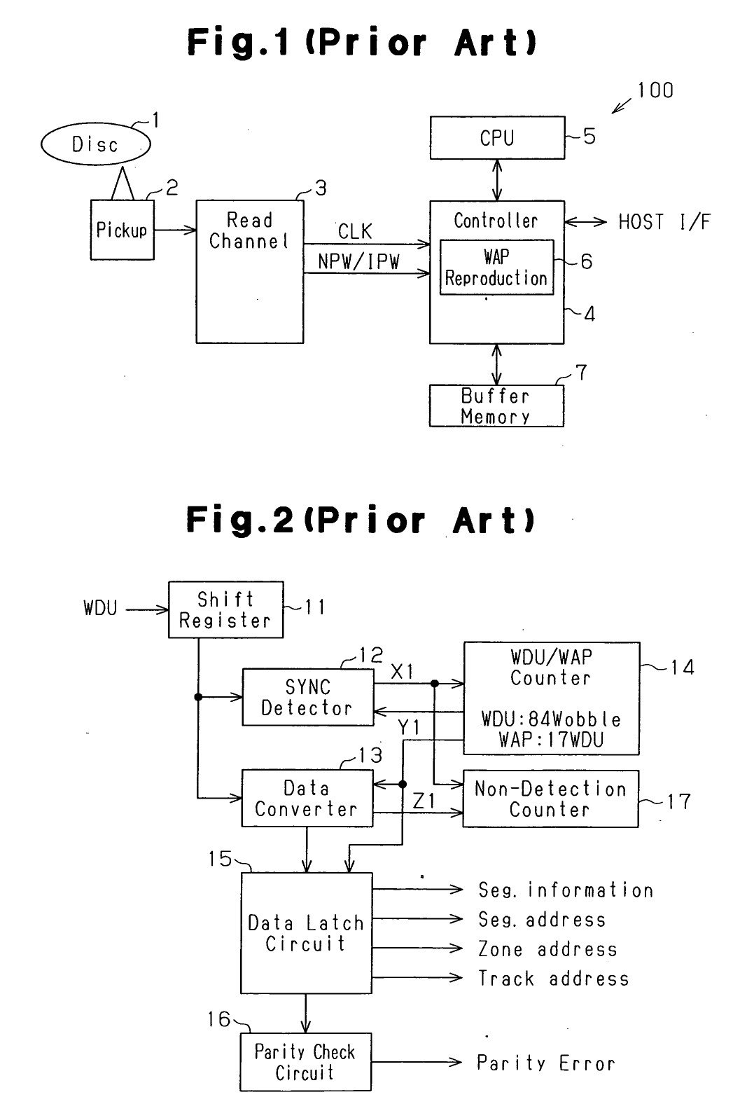

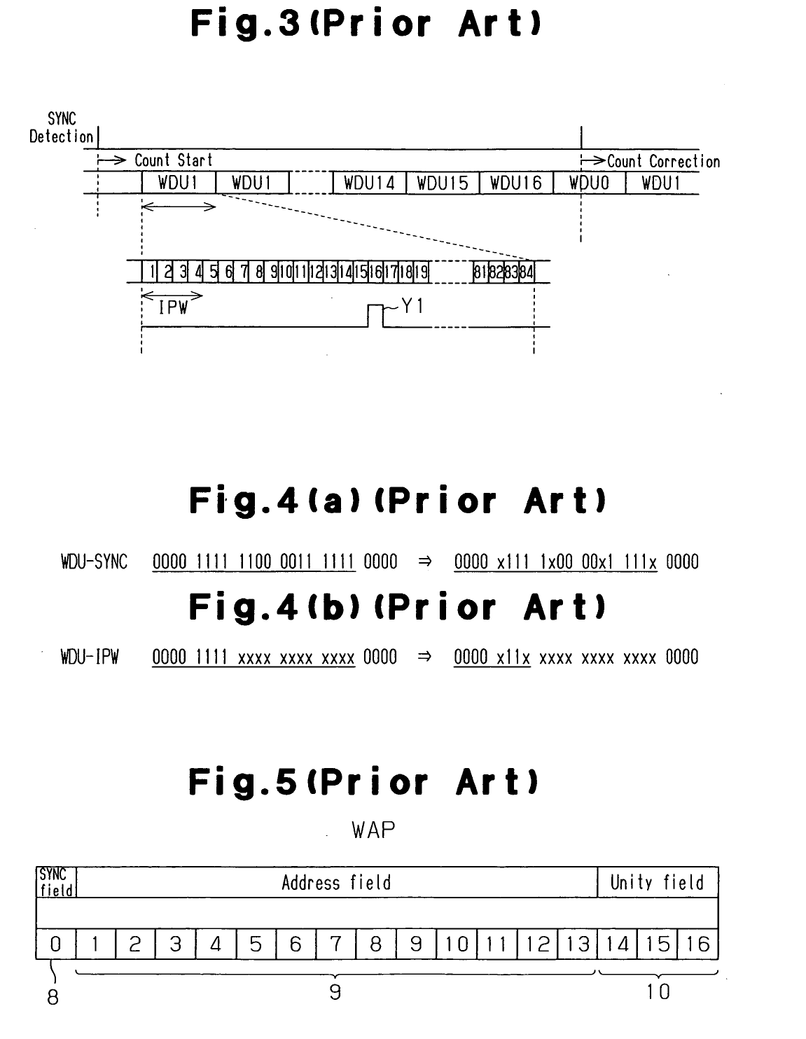

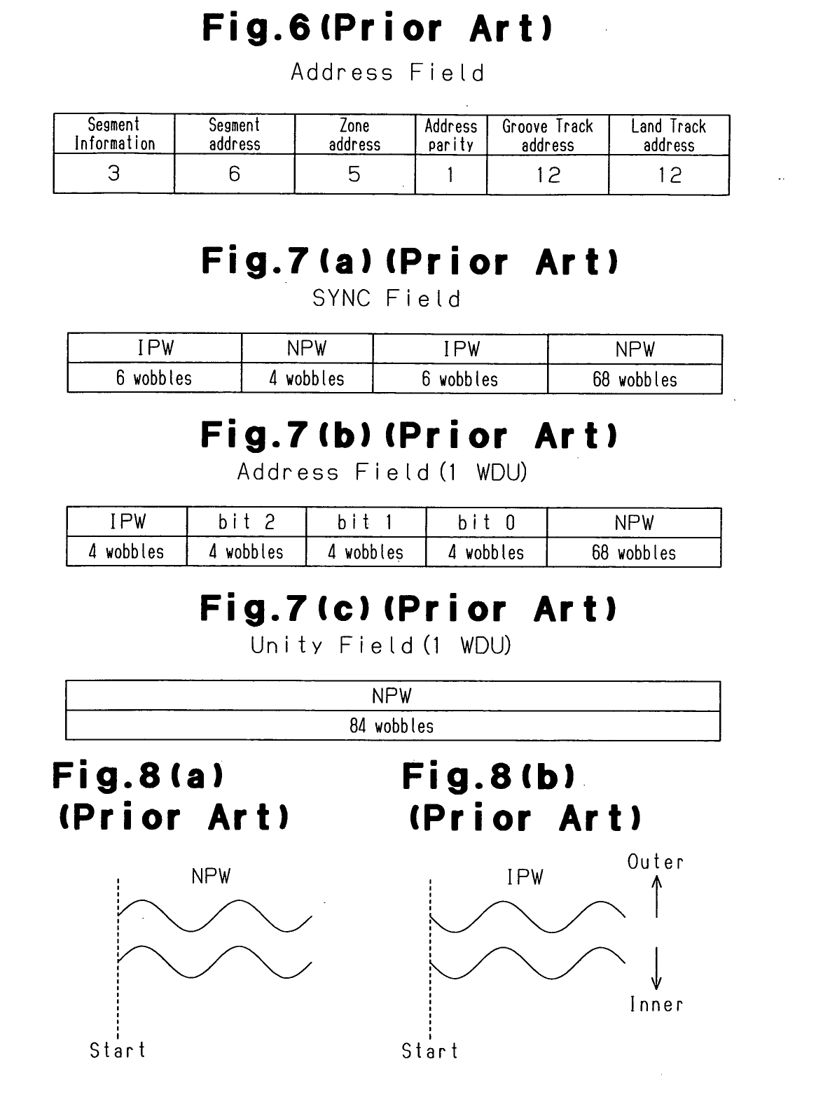

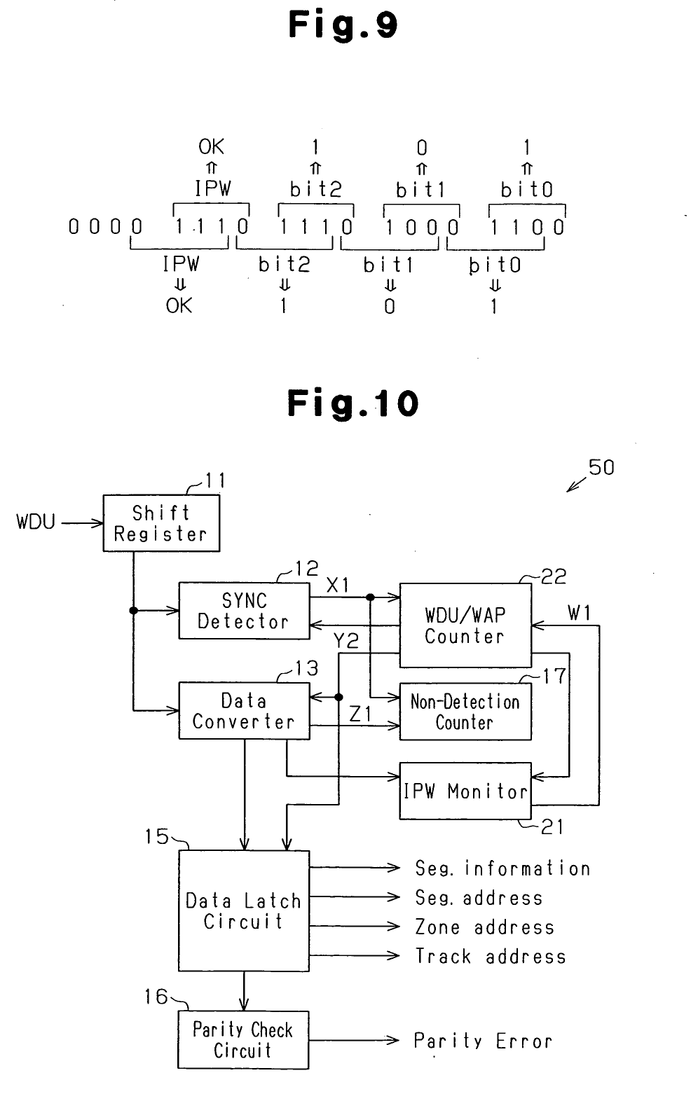

FIG. 10 is a schematic block diagram of a WAP reproduction unit 50 in an optical disc record/reproduction apparatus according to a first embodiment of the present invention. The WAP reproduction unit 50 is incorporated in the controller 4 of the optical disc record/reproduction apparatus 100 shown in FIG. 1. The optical disc record/reproduction apparatus of the first embodiment is configured in the same manner as the optical disc record/reproduction apparatus 100 of FIG. 1 except for the WAP reproduction unit 50 and is thus not shown in the drawings. A WAP (wobble address in a periodic position) having the same configuration as the WAP described in the prior art is recorded on a disc 1 as preformat information.

The WAP reproduction unit 50 includes a shift register 11, a SYNC detector 12, a data converter 13, a data latch circuit 15, a parity check circuit 16, a non-detection counter 17, an IPW monitor 21, and a WDU/WAP counter 22. The WDU/WAP counter 22 operates in cooperation with the IPW monitor 21.

The WDUs of the WAP are sequentially provided to the shift register 11. Further, wobble signals are provided to the SYNC detector 12 and to the data converter 13 in units of predetermined number of bits.

The SYNC detector 12 detects a SYNC field 8 (i.e., six wobbles of IPW, four wobbles of NPW, and six wobbles of IPW configuring the SYNC field 8) as a synchronization signal. Upon detection of the SYNC field 8, the SYNC detector 12 provides the WDU/WAP counter 22 and the non-detection counter 17 with a detection signal X1. The SYNC detector 12 is designed to generate the detection signal X1 when detecting the SYNC pattern of “1111 1100 0011 1111” or when “1” cannot be detected at locations indicated by x in two or less of the four bits in the pattern “x111 1x00 00x1 111x 0000”.

The WDU/WAP counter 22 counts seventeen WDUs 0 to 16 of one WAP in response to the detection signal X1 and counts eighty-four wobble signals (binary signals) of each WDU. Based on the count values resulting from the count operations, the WDU/WAP counter 22 provides the data converter 13 and the data latch circuit 15 with a demodulation signal Y2 at a predetermined timing.

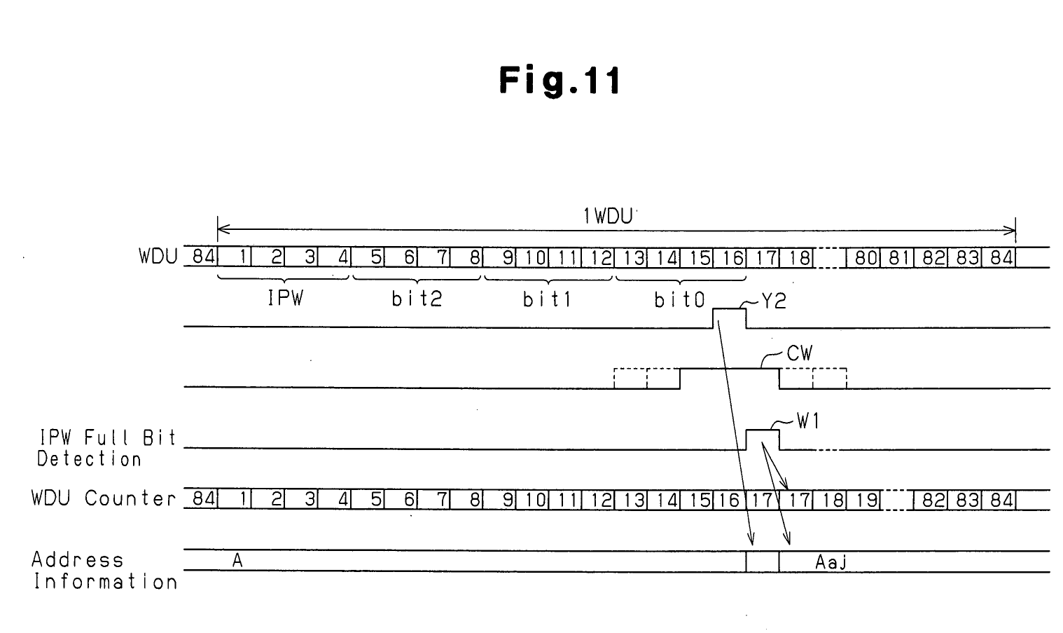

As shown in FIG. 11, the WDU/WAP counter 22 generates the demodulation signal Y2 when counting the sixteenth wobble signal of each of the WDUs 1 to 13 in the address field 9 (i.e., when the four wobbles of the wobble signals corresponding to bits 2 to 0 are input into the data converter 13 after the four wobbles of the IPW). The demodulation signal Y2 is generated in a locked state at the same timing as the 84 wobble signals of each of the WDUs 1 to 13.

In response to the demodulation signal Y2, the data converter 13 recognizes the wobble signal provided from the shift register 11 as the first IPW of each of the WDUs 1 to 13 and recognizes the wobble signal following the first IPW as address information stored in bits 2 to 0. The data converter 13 then demodulates the wobble signals. In the demodulation process, the data converter 13 performs majority determination on each of the wobble signals read from bits 2 to 0 to generate address information. The address information is provided to the data latch circuit 15. The data converter 13 provides the non-detection counter 17 with a non-detection signal Z1 when the IPW of “0000 x11x” cannot be detected.

In accordance with the demodulation signal Y2, the data latch circuit 15 sequentially latches the address information of each of WDUs 1 to 13. Upon completion of the read operation of one WAP, the data latch circuit 15 provides the parity check circuit 16 with segment information, a segment address, a zone address, and a track address.

The parity check circuit 16 performs a parity check on the address information stored in the data latch circuit 15. When detecting an error in the address information, the parity check circuit 16 generates an error signal.

The non-detection counter 17 counts the non-detection signal Z1. When the count value reaches a predetermined value, the non-detection counter 17 recognizes that the read operation of each of the WDUs 1 to 13 is anomalous and generates an error signal.

The IPW monitor 21 receives the count value of the wobble signals of each of the WDUs 1 to 84, which is provided from the WDU/WAP counter 22, and the wobble signals of each WDU, which are provided from the data converter 13. As shown in FIG. 11, the IPW monitor 21 sets an IPW monitoring window CW for a period from a first timing, which is one clock pulse before the timing the demodulation signal Y2 is generated, to a second timing, which is one clock pulse after the timing the demodulation signal Y2 is generated. The IPW monitor 21 detects full bits of the head IPW with the IPW monitoring window CW. In other words, the IPW monitor 21 sets the IPW monitoring window CW for a period expanded around the generation timing of the demodulation signal Y2, and detects full bits of the head IPW using the IPW monitoring window CW.

For example, when the count value of the counter 14 is “15”, the IPW monitor 21 checks in full bits whether the head IPW “1111” can be detected for the wobble signal corresponding to count values “84” to “3”. When the count value of the counter 14 is “16”, the IPW monitor 21 checks in full bits whether the head IPW “1111” can be detected for the wobble signal corresponding to count values “1” to “4”. When the count value of the counter 14 is “17”, the IPW monitor 21 checks in full bits whether the head IPW “1111” can be detected for the wobble signal corresponding to count values “2” to “5”. When detecting the head IPW “1111” in full bits, the IPW monitor 21 provides the WDU/WAP counter 22 with a detection signal W1.

When performing such a check, the wobble signal preceding the head IPW must be zero, and the wobble signal of bit 2 following the head IPW must all be zero. The wobble signal preceding the head IPW is an NPW for over 68 wobbles, that is, zero, and thus does not cause any problems. Although the chances of bit 2 being detected may increase or decrease depending on the values of the segment address, the zone address, etc., such increase and decrease in average do not cause any problems.

The WDU/WAP counter 22 counts a plurality of detection signals W1. When the count value reaches a predetermined value, the WDU/WAP counter 22 corrects the count value of the wobble signal. As shown in FIG. 11, the WDU/WAP counter 22 receives a detection signal W1 when the count value reaches “17”. When receiving the detection signal W1 over a predetermined number of WDUs, the WDU/WAP counter 22 suspends counting for a period of one clock pulse and decreases the count value by a value corresponding to one clock pulse. With this operation, the count value of the WDU/WAP counter 22 is corrected based on the assumption that the timing at which the head IPW “1111” can be detected in full bits is normal.

In the operation shown in FIG. 11, the timing for generating the demodulation signal Y2 is corrected to the timing for generating the detection signal W1. In other words, for subsequent WDUs, the generation timing of the demodulation signal Y2 is delayed by one clock pulse. For subsequent WDUs, demodulation is performed on the address information of bits 2 to 0 based on the demodulation signal Y2 delayed by one clock pulse. As a result, address information A is generated based on the demodulation signal Y2 prior to correction, and address information Aaj is generated based on the demodulation signal Y2 subsequent to correction.

The WAP reproduction unit 50 of the optical disc record/reproduction apparatus of the first embodiment has the advantages described below.

(1) The SYNC detector 12 and the data converter 13 perform the read operation of the IPW in each of the SYNC field 8 and the address field 9 with lowered detection accuracy. This ensures the read rate of address information.

(2) The IPW monitor 21 sets the IPW monitoring window CW for a period from the first timing, which is before the generation timing of the demodulation signal Y2, to the second timing, which is after the generation timing of the demodulation signal Y2. The IPW monitor 21 detects in full bits the head IPW of the address field 9 during the IPW monitoring window CW. Thus, even when the generation timing of the demodulation signal Y2 is deviated due to the lowered detection accuracy of the SYNC detector 12 and the data converter 13, the generation timing of the demodulation signal Y2 is corrected to the timing at which the full bits of the head IPW are detectable. Further, accurate address information is demodulated based on the demodulation signal Y2 of which generation timing has been corrected.

(3) The WDU/WAP counter 22 corrects the count value when receiving a plurality of detection signals W1. Thus, even when the IPW monitor 21 erroneously detects the head IPW and generates one detection signal W1, the count value is prevented from being corrected in an unnecessary manner as long as erroneous detection does not occur a number of times in succession.

(4) The read rate of the SYNC field 8 and the address field 9 is ensured, and the accuracy of the demodulated address information is improved.

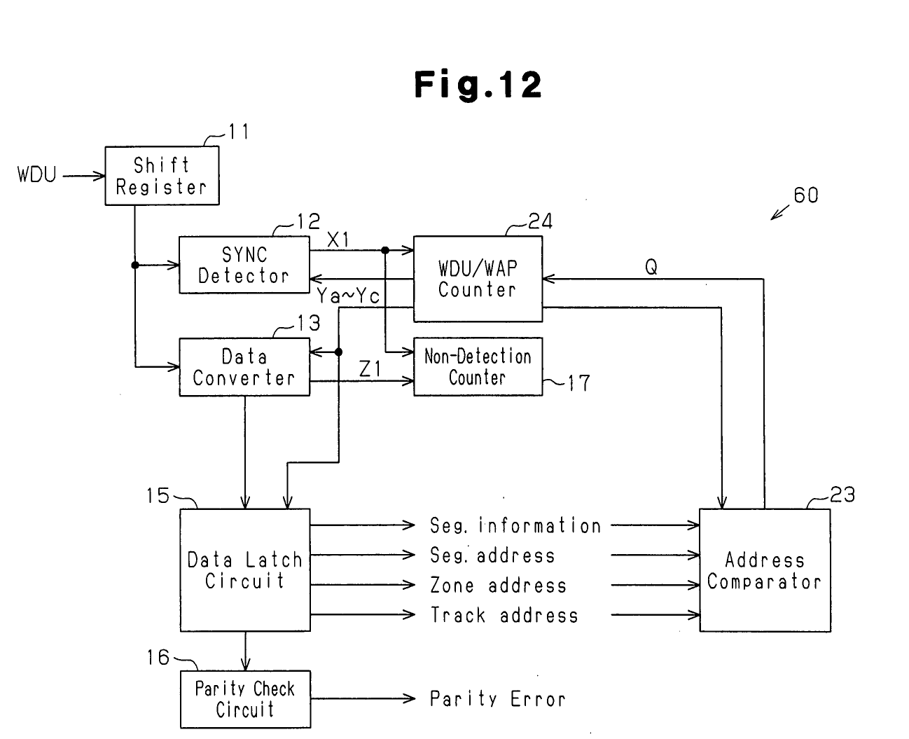

FIG. 12 is a schematic block diagram showing a WAP reproduction unit 60 according to a second embodiment of the present invention. The WAP reproduction unit 60 is incorporated in the controller 4 shown in FIG. 1. The optical disc record/reproduction apparatus of the second embodiment is configured in the same manner as the optical disc record/reproduction apparatus 100 shown in FIG. 1 except for the WAP reproduction unit 60 and is thus not shown in the drawings. A WAP having the same configuration as the WAP described in the prior art is recorded on a disc 1 as preformat information.

The WAP reproduction unit 60 includes a shift register 11, a SYNC detector 12, a data converter 13, a data latch circuit 15, a parity check circuit 16, a non-detection counter 17, an address comparator 23, and a WDU/WAP counter 24. The WDU/WAP counter 24 operates in cooperation with the address comparator 23.

The WDUs of the WAP are sequentially provided to the shift register 11. The wobble signals are provided to the SYNC detector 12 and to the data converter 13 in units of predetermined number of bits.

The operations of the SYNC detector 12, the data converter 13, the data latch circuit 15, the parity check circuit 16, and the non-detection counter 17 are the same as the operations described in the first embodiment.

The WDU/WAP counter 24 counts seventeen WDUs 0 to 16 of one WAP in response to the detection signal X1 and counts eighty-four wobble signals of each WDU. Based on the count values resulting from the count operations, the WDU/WAP counter 24 provides the data converter 13 and the data latch circuit 15 with demodulation signals Ya, Yb, and Yc at predetermined timings.

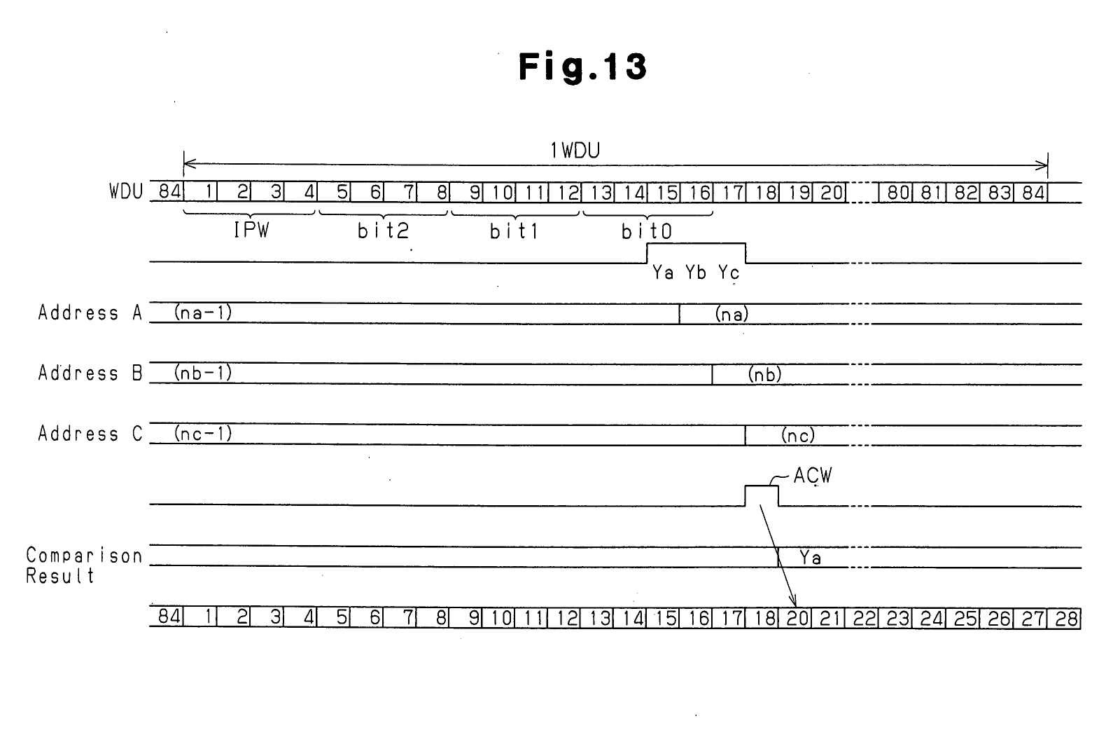

As shown in FIG. 13, the WDU/WAP counter 24 generates demodulation signals Ya, Yb, and Yc over three clock pulses at timings when respectively counting the fifteenth, sixteenth, and seventeenth wobble signals of each of the WDUs 1 to 13 included in the address field 9 (i.e., the timing when the four wobbles of wobble signals corresponding to bits 2 to 0 are provided to the data converter 13 after four wobbles of an IPW is provided). The demodulation signals Ya to Yc are generated in a locked state at the same timing for the 84 wobble signals of each of the WDUs 1 to 13.

In response to the demodulation signals Ya to Yc, the data converter 13 recognizes the wobble signal output from the shift register 11 as the first IPW of each of the WDUs 1 to 13, and recognizes the wobble signal following the first IPW as address information stored in bits 2 to 0. The data converter 13 then demodulates the wobble signals. In the demodulation process, the data converter 13 performs majority determination on each of the signals read from bits 2 to 0 to generate three sets of address information. The three sets of address information are provided to the data latch circuit 15. The data converter 13 provides the non-detection counter 17 with a non-detection signal Z1 when the IPW of “0000 x11x” cannot be detected at any one of the generation timings of the demodulation signals Ya to Yc.

According to the demodulation signals Ya to Yc, the data latch circuit 15 sequentially latches address information of each of the WDUs 1 to 13. At the timing when completing the read operation of one WAP, the data latch circuit 15 provides the parity check circuit 16 with three sets of segment information, segment address, zone address, and track address, as addresses A, B, and C.

The parity check circuit 16 performs parity check of the address information stored in the data latch circuit 15. When detecting an error, the parity check circuit 16 generates an error signal.

The non-detection counter 17 counts the non-detection signal Z1. When the count value reaches a predetermined value, the non-detection counter 17 recognizes that the read operation of each of the WDUs 1 to 13 is anomalous and generates an error signal.

The WDU/WAP counter 24 provides the address comparator 23 with an address comparison window ACW following the demodulation signals Ya to Yc. The address comparator 23 retrieves the addresses A to C in accordance with the address comparison window ACW. The address comparator 23 determines the continuity between the address values (na, nb, and nc) of the three addresses A, B, and C, which are demodulated respectively at the generation timings of the demodulation signals Ya, Yb, and Yc in the read operation of the present WAP, and the address values (na-1, nb-1, and nc-1) of the three addresses A, B, and C, which are demodulated respectively at the generation timings of the demodulation signals Ya, Yb, and Yc in the read operation of the immediately preceding WAP.

The address comparator 23 determines that the demodulation timing of the address having the highest continuity of the addresses A, B, and C is normal, and provides the WDU/WAP counter 24 with a timing correction signal Q.

FIG. 13 shows the case in which the address value na demodulated at the generation timing of the demodulation signal Ya has the highest continuity. In this case, the WDU/WAP counter 24 increases the count value by a value corresponding to one clock pulse. For subsequent WAPs, the demodulation signals Ya to Yc are generated based on the corrected count value. The demodulation operation and the address comparing operation described above are repeated.

When the address value nb demodulated at the generation timing of the demodulation signal Yb has the highest continuity in the address comparing operation, the count value of the WDU/WAP counter 24 is not corrected. When the address value nc demodulated at the generation timing of the demodulation signal Yc has the highest continuity in the address comparing operation, the count value of the WDU/WAP counter 24 is decreased by a value corresponding to one clock pulse.

In this way, the demodulation signal Yb is generated based on the uncorrected or corrected count value, and an address at which data is written is specified based on an address demodulated at the generation timing of the demodulation signal Yb.

The WAP reproduction unit 60 of the optical disc record/reproduction apparatus of the second embodiment has the advantages described below.

(1) The SYNC detector 12 and the data converter 13 perform the read operation of the IPW in each of the SYNC field 8 and the address field 9 with lowered detection accuracy. This ensures the read rate of address information.

(2) The WDU/WAP counter 24 continuously outputs the demodulation signals Ya, Yb, and Yc. Based on the demodulation signals Ya, Yb, and Yc, three sets of address information respectively corresponding to the generation timings of the demodulation signals Ya, Yb, and Yc are demodulated in each of the WDUs 1 to 13 of the address field 9, and three address values are demodulated in one WAP. For the three address values demodulated in each WAP, the address comparator 23 determines the continuity of the address values corresponding to the demodulation signals Ya to Yc. The address comparator 23 corrects the count value of the WDU/WAP counter 24 in a manner that the demodulation signal Yb is set as a signal that demodulates the address value having the highest continuity. This operation enables accurate address information to be demodulated based on the demodulation signal of which output timing has been corrected.

(3) The read rate of the SYNC field 8 and the address field 9 is ensured and the accuracy of the demodulated address information is improved.

It should be apparent to those skilled in the art that the present invention may be embodied in many other specific forms without departing from the spirit or scope of the invention. Particularly, it should be understood that the present invention may be embodied in the following forms.

In the first embodiment, the IPW monitoring window CW may be set for a period from a first timing that is one or more clock pulses before the generation timing of the demodulation signal Y2 to a second timing that is one or more clock pulses after the generation timing of the demodulation signal Y2 as indicated by the broken line in FIG. 11.

The application of the present invention should not be limited to a rewritable disc. The present invention may be applied to other types of disc having WDUs, such as a HD-DVD-recordable disc.

The present examples and embodiments are to be considered as illustrative and not restrictive, and the invention is not to be limited to the details given herein, but may be modified within the scope and equivalence of the appended claims.

What is claimed is:

1. A method for demodulating an address from a wobble signal recorded on a disc, wherein the disc records a SYNC field and an address field that are configured by a plurality of wobble data units including a first wobble data unit of the SYNC field and a second wobble data unit of the address field, the first wobble data unit including a synchronization signal, and the second wobble data unit including a head invert phase wobble, having a plurality of bits, and an address, the method comprising:
generating a plurality of wobble data units using the wobble signal recorded on the disc;
detecting the synchronization signal from the first wobble data unit of the SYNC field;
counting the plurality of wobble data units based on the detection of the synchronization signal;
generating a demodulation signal for setting a timing at which the address in the second wobble data unit of the address field is demodulated based on a count value of the plurality of wobble data units;
detecting the head invert phase wobble from the second wobble data unit of the address field in response to the demodulation signal and checking whether the plurality of wobble data units are properly readable;
demodulating the address in the second wobble data unit of the address field in response to the demodulation signal, wherein detection accuracy of the synchronization signal and the head invert phase wobble is set relatively low to improve read rate of the address;
detecting in full bit the head invert phase wobble in the second wobble data unit of the address field in parallel with the detection of the head invert phase wobble; and
correcting generation timing of the demodulation signal based on the full bit detection result so that the head invert phase wobble is properly detected.

2. The method according to claim 1, wherein said detecting in full bit the head invert phase wobble includes:
detecting in full bits the head invert phase wobble of the second wobble data unit of the address field for a period from a first timing that is one or more clock pulses prior to the generation timing of the demodulation signal to a second timing that is one or more clock pulses subsequent to the generation timing of the demodulation signal.

3. The method according to claim 1, wherein said detecting in full bits the head invert phase wobble is performed a plurality of times, and said correcting generation timing of the demodulation signal includes correcting the generation timing of the demodulation signal when the head invert phase wobble is properly detected a plurality of times.

4. A method for demodulating an address from a wobble signal recorded on a disc, wherein the disc records a SYNC field and an address field that are configured by a plurality of wobble data units including a first wobble data unit of the SYNC field and a second wobble data unit of the address field, the first wobble data unit including a synchronization signal, and the second wobble data unit including a head invert phase wobble, having a plurality of bits, and an address, the method comprising:
generating a plurality of wobble data units using wobble signal recorded on the disc;
detecting the synchronization signal from the first wobble data unit of the SYNC field;
counting the plurality of wobble data units based on the detection of the synchronization signal;
continuously generating a plurality of demodulation signals for setting a timing at which the address in the second wobble data unit of the address field is demodulated based on a count value of the plurality of wobble data units;
detecting the head invert phase wobble from the second wobble data unit of the address field and checking whether the plurality of wobble data units are properly readable;
demodulating a plurality of addresses in the second wobble data unit of the address field in response to each of the plurality of demodulation signals, wherein detection accuracy of the synchronization signal and the head invert phase wobble is set relatively low to improve read rate of the plurality of addresses;
detecting whether the plurality of addresses that are demodulated in response to the demodulation signals are proper; and
correcting, when detecting that the plurality of addresses are proper, generation timing of one of the plurality of demodulation signals so as to be synchronized with generation timings of the demodulation signal that demodulates the proper plurality of addresses.

5. The method according to claim 4, wherein said detecting whether the plurality of addresses that are demodulated in response to the demodulation signals are proper includes detecting that the plurality of addresses are proper when the plurality of addresses are continuous.

6. The method according to claim 4, wherein said correcting, when detecting that the plurality of addresses are proper, generation timing of one of the plurality of demodulation signals includes correcting the count value of the plurality of wobble data units.

7. An apparatus for demodulating an address from a wobble signal recorded on a disc, wherein the disc records a SYNC field and an address field that are configured by a plurality of wobble data units including a first wobble data unit of the SYNC field and a second wobble data unit of the address field, the first wobble data unit including a synchronization signal, and the second wobble data unit including a head invert phase wobble, having a plurality of bits, and an address, the apparatus comprising:
a SYNC detector for detecting the synchronization signal from the first wobble data unit of the SYNC field and generating a first detection signal;
a counter for counting the plurality of wobble data units in response to the first detection signal from the SYNC detector and generating a demodulation signal for setting a timing at which the address in the second wobble data unit of the address field is demodulated based on a count value of the plurality of wobble data units;
an address demodulator for detecting the head invert phase wobble in the second wobble data unit of the address field in response to the demodulation signal and demodulating the address in the second wobble data unit of the address field; and
an IPW monitor for detecting in full bit the head invert phase wobble of the second wobble data unit of the address field in parallel with the detection of the head invert phase wobble and for generating a second detection signal when properly detecting the head invert phase wobble;
wherein the counter corrects the count value in response to the second detection signal so that the demodulation signal is generated at a timing in which the head invert phase wobble is properly detectable in full bits.

8. The apparatus according to claim 7, wherein the address demodulator generates a non-detection signal when the head invert phase wobble in the second wobble data unit of the address field is not detected, the apparatus further comprising:
a non-detection counter for counting the non-detection signal of the head invert phase wobble.

9. The apparatus according claim 7, wherein the IPW monitor detects in full bits the head invert phase wobble of the second wobble data unit of the address field for a period from a first timing that is one or more clock pulses prior to generation timing of the demodulation signal to a second timing that is one or more clock pulses subsequent to the generation timing of the demodulation signal.

10. The apparatus according to claim 7, wherein the IPW monitor detects in full bits the head invert phase wobble a plurality of times, and the counter corrects the count value when the head invert phase wobble is properly detected a plurality of times.

11. An apparatus for demodulating an address from a wobble signal recorded on a disc, wherein the disc records a SYNC field and an address field that are configured by a plurality of wobble data units including a first wobble data unit of the SYNC field and a second wobble data unit of the address field, the first wobble data unit including a synchronization signal, and the second wobble data unit including a head invert phase wobble, having a plurality of bits, and an address, the apparatus comprising:
a SYNC detector for detecting the synchronization signal from the first wobble data unit of the SYNC field and generating a first detection signal;
a counter for counting the plurality of wobble data units in response to the detection signal from the SYNC detector and continuously generating a plurality of demodulation signals for setting a timing at which the address in the second wobble data unit of the address field is demodulated based on a count value of the plurality of wobble data units;
an address demodulator for detecting the head invert phase wobble from the second wobble data unit of the address field in response to each of the plurality of demodulation signals and demodulating a plurality of addresses in the second wobble data unit of in the address field; and
an address comparator for detecting whether the plurality of addresses are proper, and when detecting that the plurality of addresses are proper, providing the counter with a correction signal for correcting generation timing of one of the plurality of demodulation signals so as to be synchronized with generation timings of the demodulation signal that demodulates the proper plurality of normal addresses.

12. The apparatus according claim 11, wherein the address demodulator generates a non-detection signal when the head invert phase wobble in the second wobble data unit of the address field is not detected, the apparatus further comprising:
a non-detection counter for counting the non-detection signal of the head invert phase wobble.

13. The apparatus according claim 11, wherein the address comparator detects that the plurality of addresses are proper when the plurality of addresses are continuous.

14. The apparatus according claim 11, wherein the correction signal for correcting the generation timing of one of the plurality of demodulation signals is a correction signal for correcting the count value of the plurality of wobble data units.
